(19) United States
(12) Patent Application Publication
(10) Pub. No.: US 2026/0211299 A1
(43) Pub. Date: Jul. 23, 2026

(54) Camera Device

(71) Applicant: HITACHI ASTEMO, LTD., Ibaraki (JP)

(72) Inventors: Seiichi KATOU, Chiyoda-ku, Tokyo (JP); Hidenori SHINOHARA, Hitachinaka-shi, Ibaraki (JP); Naoki OKA, Hitachinaka-shi, Ibaraki (JP); Shigeto HIROHATA, Hitachinaka-shi, Ibaraki (JP)

(21) Appl. No.: 19/139,941

(22) PCT Filed: Nov. 20, 2023
(86) PCT No.: PCT/JP2023/041597

§ 371 Date: Jun. 17, 2025

(30) Foreign Application Priority Data
Dec. 22, 2022 (JP) 2022-205042

(51) Int. Cl. G03B 17/08

(52) U.S. Cl. CPC G03B 17/08

(57) ABSTRACT

A camera device includes a waterproof case, a transparent portion provided in the waterproof case, and a front slope formed from one end portion of the transparent portion in the waterproof case and provided in front of the transparent portion in an optical axis direction (third direction Z). The front slope is inclined with respect to the optical axis direction.

### TECHNICAL FIELD

The present invention relates to a camera device.

### BACKGROUND ART

In recent years, actual vehicle mounting of a driver assistance system has progressed. Under such circumstances, systems, such as a collision damage reduction braking device that automatically performs a stop operation before collision, an inter-vehicle automatic control device that automatically tracks a preceding vehicle, a lane deviation suppression device, and sign recognition, which seek safety, convenience, and comfort of a driver and a passenger, have been developed. As such a system, for example, there is an external recognition system that recognizes a vehicle, a pedestrian, and the like and measures a distance of an object. As an example of the external recognition system, a camera device is used. A camera device mounted on such a vehicle is used even in rainy weather, and thus has a waterproof function.

As such a camera device, for example, there is a camera device as described in PTL 1. PTL 1 describes a technique in which, in a camera device provided with a lens substantially at the center of a front surface of a housing and provided with a camera mechanism inside the housing, a guide path for causing attached water droplets to flow down from above with respect to the lens is formed on an upper surface portion of the housing.

Furthermore, as such a camera device, for example, there is a camera device as described in PTL 2. PTL 2 describes a technique including a camera that photographs the front of a traveling machine body, a case body in which the camera is accommodated and supported, and a support mechanism that supports the case body on the traveling machine body side. In addition, PTL 2 describes that a case body includes a plate-shaped glass body disposed in front of a camera via a support packing and a cylindrical front cover portion disposed in front of the glass body, and the glass body is attached in an inclined state with respect to the camera.

### CITATION LIST

### Patent Literature

PTL 1: JP 2015-207020 A

PTL 2: JP 2022-79048 A

### SUMMARY OF INVENTION

### Technical Problem

However, since the technique described in PTL 1 is only a waterproof structure, it does not have a configuration for removing water droplets attached to the transparent portion. Therefore, there is a problem that not only the visual field is hindered by the water droplet attached to the transparent portion, but also the image is distorted due to refraction of light by the water droplet or the like, and the distance measuring performance of the camera device is deteriorated.

In addition, in the technique described in PTL 2, since the glass body is disposed to be inclined with respect to the optical axis, the optical path length changes along the viewing direction, and there is a possibility that distortion occurs in the image sensed by the imaging element.

In consideration of the above problems, an object of the present invention is to provide a highly reliable camera device capable of removing a water droplet attached to a transparent portion and having high measurement accuracy.

### Solution to Problem

In order to solve the above problems and achieve the object, a camera device includes: a housing component that houses an imaging unit; a transparent portion provided in the housing component and positioned in an imaging range of the imaging unit; and a front slope formed from one end portion of the transparent portion in the housing component and provided in front of the transparent portion in an optical axis direction of the imaging unit. The front slope is inclined with respect to the optical axis direction.

### Advantageous Effects of Invention

According to the camera device having the above configuration, it is possible to remove a water droplet attached to the transparent portion, and it is possible to enhance reliability with high measurement accuracy.

### BRIEF DESCRIPTION OF DRAWINGS

FIG. 1 is a perspective view illustrating a camera device according to a first embodiment.

FIG. 2 is a plan view of the periphery of a transparent portion in the camera device according to the first embodiment as viewed from above.

FIG. 3 is a perspective view illustrating an example of a conventional camera device.

FIG. 4 is a side view illustrating an example of the conventional camera device.

FIG. 5 is a side view illustrating another example of the conventional camera device.

FIG. 6 is a diagram illustrating a relationship between an inclination angle of a slope and a wind speed in the camera device according to the first embodiment.

FIG. 7 is a perspective view illustrating a camera device according to a second embodiment.

FIG. 8 is a plan view of the periphery of a transparent portion in the camera device according to the second embodiment as viewed from above.

FIG. 9 is a perspective view illustrating a camera device according to a third embodiment.

FIG. 10 is a plan view of the periphery of a transparent portion in the camera device according to the third embodiment as viewed from above.

FIG. 11 is a perspective view illustrating a camera device according to a fourth embodiment.

FIG. 12 is a perspective view illustrating a camera device according to a fifth embodiment.

FIG. 13 is a side view illustrating the camera device according to the fifth embodiment.

FIG. 14 is a perspective view illustrating a camera device according to a sixth embodiment.

FIG. 15 is a plan view of the periphery of a lens in the camera device according to the sixth embodiment as viewed from above.

### DESCRIPTION OF EMBODIMENTS

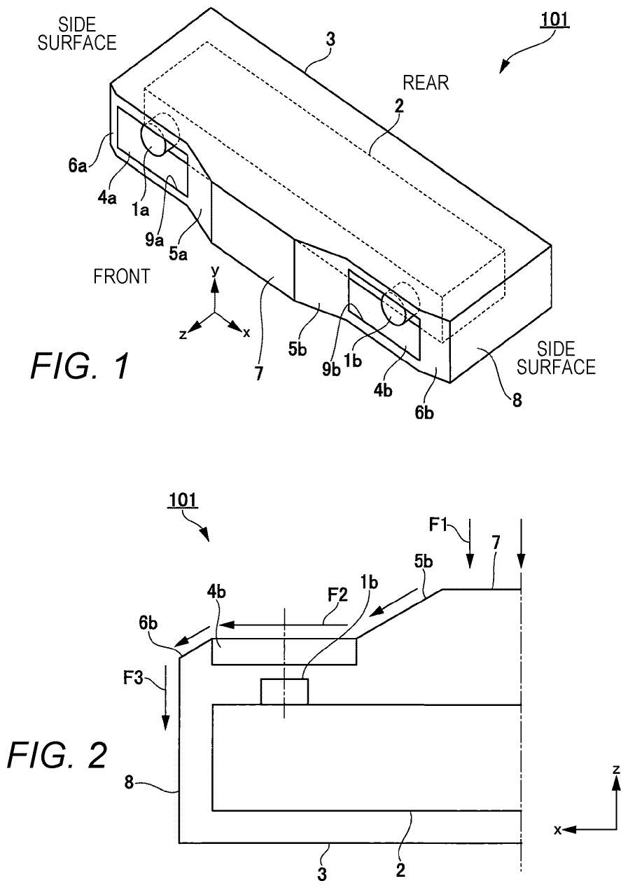

Hereinafter, an embodiment of a camera device will be described with reference to FIGS. 1 to 15. The common members in each drawing are designated by the same reference numerals.

### 1. First Embodiment

### 1-1. Configuration of Camera Device

First, a configuration of a camera device according to a first embodiment (hereinafter, referred to as “present example”) will be described with reference to FIGS. 1 and 2.

FIG. 1 is a perspective view of a camera device. FIG. 2 is a plan view of the periphery of a transparent portion in the camera device as viewed from above.

The device illustrated in FIG. 1 is a camera device mounted on a vehicle such as an automobile or a two-wheeled vehicle. As illustrated in FIG. 1, a camera device 101 includes a stereo camera 2 and a waterproof case 3 illustrating an example of a housing component. The stereo camera 2 includes two lenses 1a and 1b and an imaging element indicating an imaging unit (not illustrated). Then, the stereo camera 2 captures an image obtained through the two lenses 1a and 1b using an imaging element. The stereo camera 2 is accommodated in the waterproof case 3.

Hereinafter, a direction in which the two lenses 1a and 1b are arranged is referred to as a first direction X, and a direction orthogonal to the first direction X and parallel to the vertical direction is referred to as a second direction Y. A direction orthogonal to the first direction X and the second direction Y is defined as a third direction Z. Note that the lenses 1a and 1b are arranged in front of the main body of the stereo camera 2 in the third direction Z. The third direction Z is parallel to the optical axis direction of the lenses 1a and 1b and the traveling direction of the vehicle.

The waterproof case 3 is formed in a hollow container shape. A front surface portion 7 is formed in front of the waterproof case 3 in the third direction Z. A first opening 9a and a second opening 9b are formed in the front surface portion 7.

The first opening 9a is formed on one side in the first direction X in the front surface portion 7, and the second opening 9b is formed on the other side in the first direction X in the front surface portion 7. In addition, the first opening 9a is formed at a position facing the first lens 1a of the stereo camera 2, and the second opening 9b is formed at a position facing the second lens 1b of the stereo camera 2. The first opening 9a is disposed in front of the first lens 1a in the third direction Z, and the second opening 9b is disposed in front of the second lens 1b in the third direction Z. The sizes of the openings of the first opening 9a and the second opening 9b are set according to the imaging range of the stereo camera 2.

A first transparent portion 4a is fitted into the first opening 9a, and a second transparent portion 4b is fitted into the second opening 9b. Therefore, the first transparent portion 4a is disposed in front of the first lens 1a in the third direction Z, and the second transparent portion 4b is disposed in front of the second lens 1b in the third direction Z. The first transparent portion 4a and the second transparent portion 4b are formed in a flat plate shape. As illustrated in FIG. 2, one surface of each of the first transparent portion 4a and the second transparent portion 4b is disposed in parallel with a plane orthogonal to the third direction Z. The first transparent portion 4a and the second transparent portion 4b are configured to transmit light toward the imaging element, and are located in an imaging range of the imaging unit.

In addition, a front slope 5a is formed on the center side in the first direction X with respect to the first transparent portion 4a in the waterproof case 3. A rear slope 6a is formed outside in the first direction X with respect to the first transparent portion 4a in the waterproof case 3, that is, on the side of a side surface portion 8 of the waterproof case 3. A front slope 5b is formed on the center side in the first direction X with respect to the second transparent portion 4b in the waterproof case 3. A rear slope 6b is formed outside in the first direction X with respect to the second transparent portion 4b in the waterproof case 3, that is, on the side of the side surface portion 8 of the waterproof case 3.

The first transparent portion 4a and the second transparent portion 4b have the same configuration. The front slope 5a and the front slope 5b have the same configuration. The rear slope 6a and the rear slope 6b also have the same configuration. Therefore, in the following description, the second transparent portion 4b, the front slope 5b, and the rear slope 6b will be described.

As illustrated in FIG. 2, one surface of the second transparent portion 4b is disposed in parallel with a plane orthogonal to the third direction Z. That is, one surface of the second transparent portion 4b is disposed parallel to a plane orthogonal to the optical axis direction of the second lens 1b.

The front slope 5b is formed at one end portion on the central side of the second transparent portion 4b in the first direction X. The front slope 5b is inclined forward in the third direction Z as the front slope 5b is away from one end portion of the second transparent portion 4b. The rear slope 6b is formed at the other end portion on the outer side of the second transparent portion 4b in the first direction X. The rear slope 6b is inclined backward in the third direction Z as the rear slope 6b is away from the other end portion of the second transparent portion 4b. Therefore, the front slope 5b is disposed in front of the second transparent portion 4b in the third direction Z, and the rear slope 6b is disposed behind the second transparent portion 4b in the third direction Z.

The front slope 5b and the rear slope 6b are inclined with respect to a plane orthogonal to the third direction Z, and in the present example, are inclined with respect to the third direction Z and the first direction X. The front slope 5b and the rear slope 6b are formed in a flat plate shape, and the inclined surfaces thereof are planar.

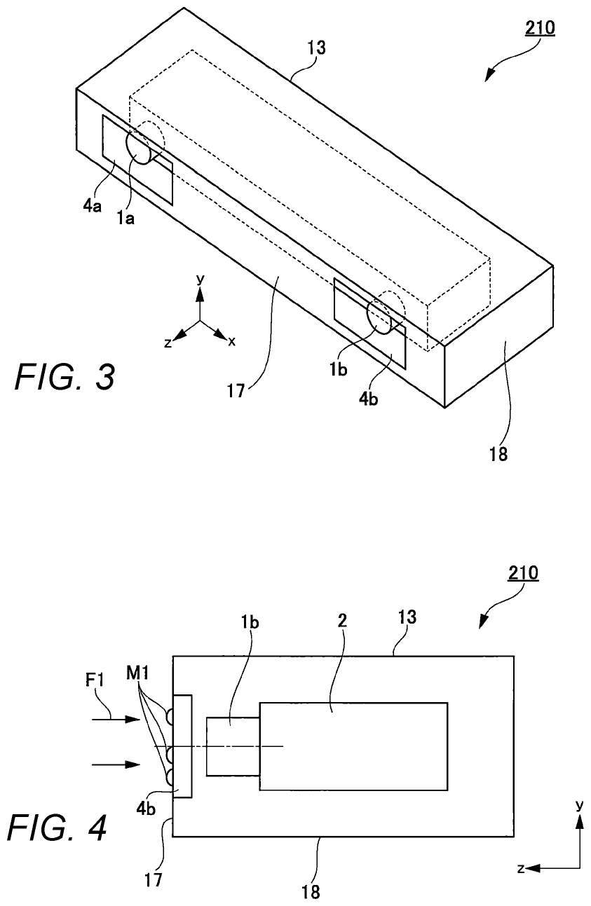

Here, a conventional camera device will be described with reference to FIGS. 3 to 5.

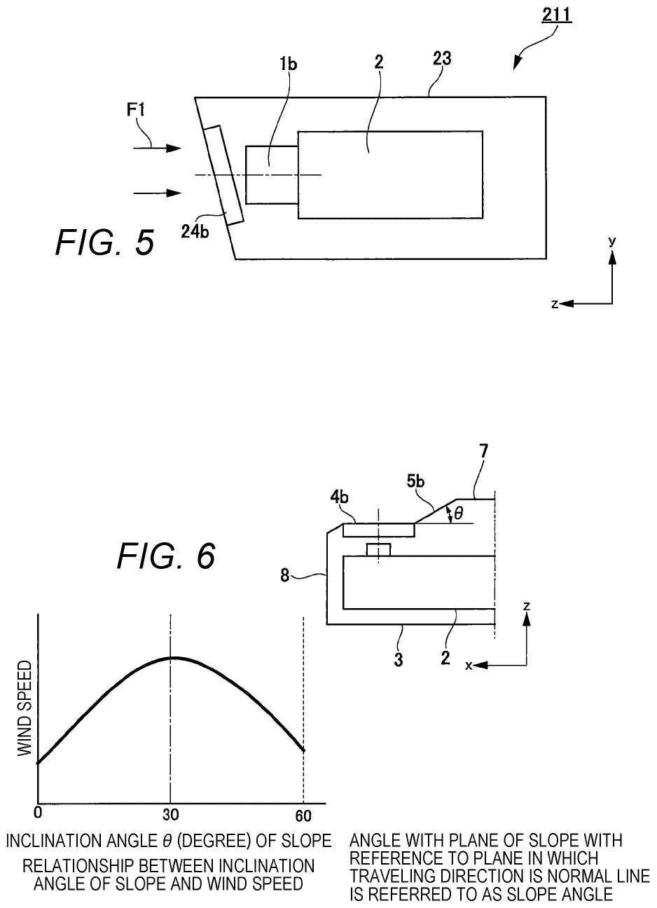

FIG. 3 is a perspective view illustrating an example of the conventional camera device and a side view illustrating an example of the conventional camera device. FIG. 5 is a side view illustrating another example of the conventional camera device. Note that portions common to those of the camera device 101 of the present example are denoted by the same reference numerals, and redundant description will be omitted.

As illustrated in FIGS. 3 and 4, a conventional camera device 210 includes a stereo camera 2 and a waterproof case 13. A front surface portion 17 of the waterproof case 13 is provided with two transparent portions 4a and 4b. The two transparent portions 4a and 4b are arranged at positions facing the lenses 1a and 1b of the stereo camera 2. The front surface portion 17 of the waterproof case 13 is formed in a flat plate shape.

As illustrated in FIG. 4, a traveling wind Fl generated during traveling of the vehicle is blown to the transparent portions 4a and 4b along the third direction Z. When a water droplet M1 adheres to the transparent portions 4a and 4b during traveling such as rainy weather, the water droplet M1 is pressed against the transparent portions 4a and 4b by the traveling wind F1. As a result, the water droplet M1 remains attached to the transparent portions 4a and 4b without being removed.

When the water droplet M1 adheres to the transparent portions 4a and 4b, the water droplet M1 obstructs the visual field of the stereo camera 2 or causes image distortion due to light refraction or the like. As a result, the water droplet M1 attached to the transparent portions 4a and 4b deteriorates the distance measuring performance of the camera device 210.

Furthermore, a camera device 211 illustrated in another conventional example illustrated in FIG. 5 includes a stereo camera 2 and a waterproof case 23. A transparent portion 24b is disposed at a position facing the lens 1b of the stereo camera 2 in the waterproof case 23. The transparent portion 24b is inclined with respect to a plane orthogonal to the third direction Z, and is inclined with respect to the second direction Y in the example illustrated in FIG. 5. That is, the transparent portion 24b of the camera device 211 illustrated in FIG. 5 is inclined with respect to the optical axis of the lens 1b.

Therefore, the length from the transparent portion 24b to the lens 1b in the third direction Z changes. As a result, since the optical path length of the light passing through the transparent portion 24b changes depending on the viewing direction, distortion occurs in the image formed by the lens 1b, and there is a possibility that the distance measuring performance of the camera device 211 is deteriorated.

On the other hand, as illustrated in FIG. 2, in the camera device 101 of the present example, the transparent portions 4a and 4b are formed in a planar shape with respect to the direction orthogonal to the optical axes of the lenses 1a and 1b. As result, the optical path length can be prevented from being changed by the transparent portions 4a and 4b, and distortion can be prevented from occurring in the images formed by the lenses 1a and 1b.

The front slopes 5a and 5b are provided on one side of the transparent portions 4a and 4b, and the rear slopes 6a and 6b are provided on the other side of the transparent portions 4a and 4b. Therefore, when the traveling wind F1 is applied to the waterproof case 3 from the front of the camera device 101, the direction of the traveling wind F1 first changes in a direction parallel to the first direction X by the front slopes 5a and 5b.

Then, a wind (hereinafter, referred to as “first guide wind”) F2 changed in direction by the front slopes 5a and 5b passes on one surface of the transparent portions 4a and 4b from the center side toward the outside in the first direction X. Therefore, the water droplets M1 attached to the transparent portions 4a and 4b are removed by the first guide wind F2.

The direction of the first guide wind F2 that has passed through the transparent portions 4a and 4b is changed by the rear slopes 6a and 6b backward in the third direction Z. Then, a wind (hereinafter, referred to as “second guide wind”) F3 changed in direction by the rear slopes 6a and 6b flows to the rear side of the waterproof case 3 along the side surface portion 8 of the waterproof case 3. Therefore, the water droplets M1 removed from the transparent portions 4a and 4b are discharged to the side surface portion 8 of the waterproof case 3 and the outside of the waterproof case 3 by the second guide wind F3. In this manner, the water droplets M1 can be prevented from staying at the other end portions of the transparent portions 4a and 4b by the rear slopes 6a and 6b.

As described above, according to the camera device 101 of the present example, since the water droplet M1 attached to the transparent portions 4a and 4b can be removed using the traveling wind F1, the first guide wind F2, and the second guide wind F3, it is possible to provide the camera device 101 with high measurement accuracy and high reliability.

Here, the effect of removing the water droplets M1 from the transparent portions 4a and 4b is higher in the first guide wind F2 passing above one surface of the transparent portions 4a and 4b than in the second guide wind F3. Therefore, it is important to provide the front slopes 5a and 5b provided in front of the transparent portions 4a and 4b in the third direction Z, and the rear slopes 6a and 6b may not be provided. In addition, the inclination angles of the front slopes 5a and 5b and the inclination angles of the rear slopes 6a and 6b may be the same or different.

Note that, in the above description, it has been described that the water droplets M1 such as a raindrop adhere to the transparent portions 4a and 4b on the assumption of traveling in rainy weather, but the present invention is not limited thereto. According to the camera device 101 of the present example, not only the water droplet M1 but also dust and the like can be removed from the transparent portions 4a and 4b. As a result, the camera device 101 of the present example can also be used as a countermeasure against dust attached when traveling on a bad road such as outside a road. Therefore, the waterproof case 3 described as an example of the housing component may be a dustproof case.

### 1-2. Inclination Angle of Slope

Next, inclination angles of the front slopes 5a and 5b and the rear slopes 6a and 6b will be described with reference to FIG. 6.

FIG. 6 is a diagram illustrating a relationship between the inclination angles of the slopes 5a, 5b, 6a, and 6b and the wind speed.

Here, an angle between the planes of the front slopes 5a and 5b and the planes of the rear slopes 6a and 6b with respect to a plane having a third direction Z, which is a traveling direction of the vehicle, as a normal line is referred to as an inclination angle θ. As illustrated in FIG. 6, it can be seen that the wind speeds of the first guide wind F2 and the second guide wind F3 are maximized when the inclination angle θ is about 30 degrees. Therefore, it is preferable to set the inclination angle θ of the front slopes 5a and 5b and the rear slopes 6a and 6b in the range of 15 to 45 degrees in consideration of variations in components and the like.

Note that, although the example of using the stereo camera 2 has been described in the camera device 101 of the present example, the type of the camera is not limited thereto, and various other cameras such as a monocular camera and a triplet-lens camera can be applied.

In addition, the transparent portions 4a and 4b are fitted into the openings 9a and 9b, but the present invention is not limited thereto. For example, the waterproof case 3 may be molded integrally with the transparent portions 4a and 4b using a molded member such as resin, and portions other than the transparent portions 4a and 4b may be made opaque by coating. As described above, manufacturing the waterproof case by integral molding can reduce the cost.

### 2. Second Embodiment

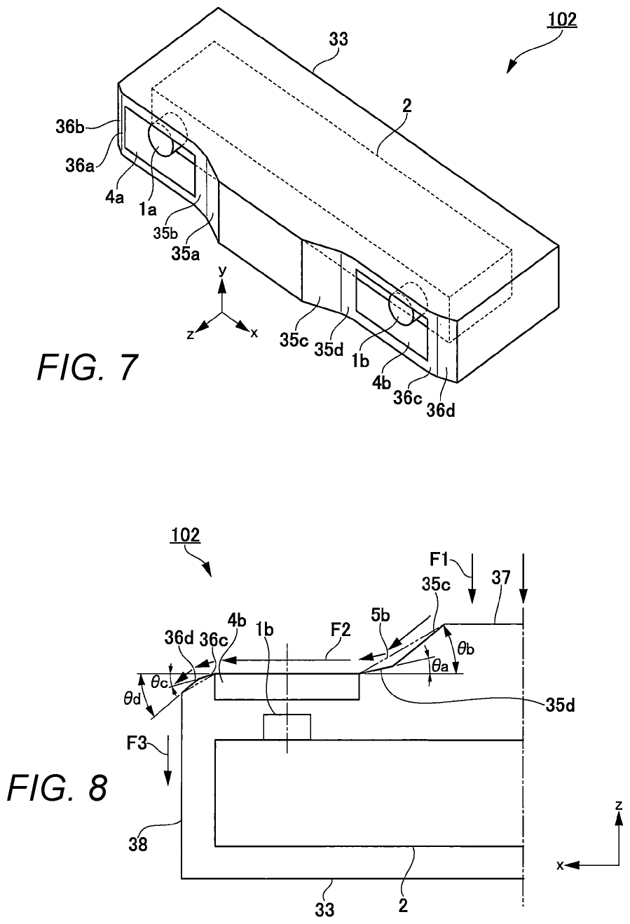

Next, a camera device according to a second embodiment will be described with reference to FIGS. 7 and 8.

FIG. 7 is a perspective view illustrating a camera device according to the second embodiment, and FIG. 8 is a plan view of the periphery of a transparent portion as viewed from above.

A camera device 102 according to the second embodiment is different from the camera device 101 according to the first embodiment in the configuration of the slope. Therefore, portions common to those of the camera device 101 according to the first embodiment are denoted by one reference numeral, and redundant description will be omitted.

As illustrated in FIG. 7, the camera device 102 according to the second embodiment includes a stereo camera 2 and a waterproof case 33 illustrating an example of a housing component. The transparent portions 4a and 4b are provided at positions facing the lenses 1a and 1b in a front surface portion 37 of the waterproof case 33.

A first front slope 35a and a second front slope 35b are formed on the center side of the first transparent portion 4a in the first direction X. A first rear slope 36a and a second rear slope 36b are formed on a side surface portion 38 side in the first transparent portion 4a in the first direction X. Similarly, a first front slope 35c and a second front slope 35d are formed on the center side of the second transparent portion 4b in the first direction X. A first rear slope 36c and a second rear slope 36d are formed on the side surface portion 38 side in the second transparent portion 4b in the first direction X.

Note that the first front slope 35a and the second front slope 35b and the first front slope 35c and the second front slope 35d have the same configuration, and the first rear slope 36a and the second rear slope 36b and the first rear slope 36c and the second rear slope 36d have the same configuration. Therefore, here, the first front slope 35c and the second front slope 35d and the first rear slope 36c and the second rear slope 36d, which are on the second transparent portion 4b side, will be described.

As illustrated in FIG. 8, the second front slope 35d is formed from one end portion of the second transparent portion 4b on the central side in the first direction X. The first front slope 35c is formed continuously from an end portion of the second front slope 35d on a side opposite to the second transparent portion 4 b. A first forward inclination angle θb, which is the inclination angle of the first front slope 35c, is larger than a second forward inclination angle θa, which is the inclination angle of the second front slope 35d (θb>θa).

That is, the first forward inclination angle θb is closer to the third direction Z, which is the traveling direction, than the second forward inclination angle θa. The second forward inclination angle θa is closer to the first direction X, which is a direction parallel to one surface of the second transparent portion 4b, than the first forward inclination angle θb. Therefore, the difference in inclination angle between the second forward inclination angle θa and the one surface of the second transparent portion 4b is smaller than the difference in inclination angle between the first forward inclination angle θb and the one surface of the second transparent portion 4b.

Therefore, in the camera device 102 according to the second embodiment, the inclination angles of the front slopes 35c and 35d are changed in stages. As the second transparent portion 4b comes closer, the inclination angle of the second transparent portion 4b comes closer to one surface of the second transparent portion 4b. As a result, the direction of the traveling wind F1 can be efficiently changed to the direction of the first guide wind F2. As a result, since the air volume can be increased to the first guide wind F2 which is the wind for removing the water droplet MI attached to the second transparent portion 4b, the water droplet M1 can be more efficiently removed from the second transparent portion 4b.

In addition, a corner where the second front slope 35d and the second transparent portion 4b intersect is a portion where stagnation of air is likely to occur. On the other hand, by reducing the difference in inclination angle between the second forward inclination angle θa and the one surface of the second transparent portion 4b, it is possible to suppress stagnation of air at the corner where the second front slope 35d and the second transparent portion 4b intersect. As a result, the first guide wind F2 can smoothly pass over the one surface of the second transparent portion 4b.

The first rear slope 36c is formed from the other end portion of the second transparent portion 4b on the outer side in the first direction X. The second rear slope 36d is formed continuously from an end portion of the first rear slope 36c on a side opposite to the second transparent portion 4b. A first rear inclination angle θc, which is the inclination angle of the first rear slope 36c, is smaller than a second rear inclination angle θd, which is the inclination angle of the second rear slope 36d (θd>θc).

That is, the first rear inclination angle θc is closer to the first direction X that is a direction parallel to one surface of the second transparent portion 4b than the second rear inclination angle θd. The second rear inclination angle θa is closer to the third direction Z, which is the traveling direction, than the first rear inclination angle θb. Therefore, the difference in inclination angle between the first rear inclination angle θc and the one surface of the second transparent portion 4b is smaller than the difference in inclination angle between the second rear inclination angle ed and the one surface of the second transparent portion 4b.

Therefore, in the camera device 102 according to the second embodiment, the inclination angles of the rear slopes 36c and 36d are changed in stages. As the second transparent portion 4b comes closer, the inclination angle of the second transparent portion 4b comes closer to one surface of the second transparent portion 4b.

Here, the corner where the first rear slope 36c and the second transparent portion 4b intersect is a place where separation of air is likely to occur. Therefore, the water droplet M1 may be scattered at a corner where the first rear slope 36c and the second transparent portion 4b intersect, and the scattered water droplet MI may adhere to the second transparent portion 4b again. On the other hand, as described above, by reducing the difference in the inclination angle between the first rear inclination angle θc and the one surface of the second transparent portion 4b, the water droplet M1 can be first separated from the second transparent portion 4b. As a result, it is possible to prevent the water droplet M1 from scattering and adhering to the second transparent portion 4b again.

Other configurations are similar to those of the camera device 101 according to the first embodiment, and thus, description thereof will be omitted. The camera device 102 having such a configuration can also obtain the same operational effects as those of the camera device 101 according to the first embodiment described above.

Note that, in the camera device 102 according to the second embodiment, an example in which the inclination angles of the front slope and the rear slope are changed in two stages has been described, but the present invention is not limited thereto, and the inclination angles of the front slope and the rear slope may be changed in three or more stages.

Furthermore, in the camera device 101 according to the first embodiment and the camera device 102 according to the second embodiment, an example in which the front slope and the rear slope are formed in a planar shape has been described, but the present invention is not limited thereto. For example, the front slope and the rear slope may be changed to a curved surface shape, or may be formed to a curved surface shape in which the radius of curvature continuously increases as approaching the transparent portion. However, in a case where the front slope and the rear slope are formed in curved shapes, a vortex of air may be generated. Therefore, the front slope and the rear slope are preferably formed in a planar shape.

### 3. Third Embodiment

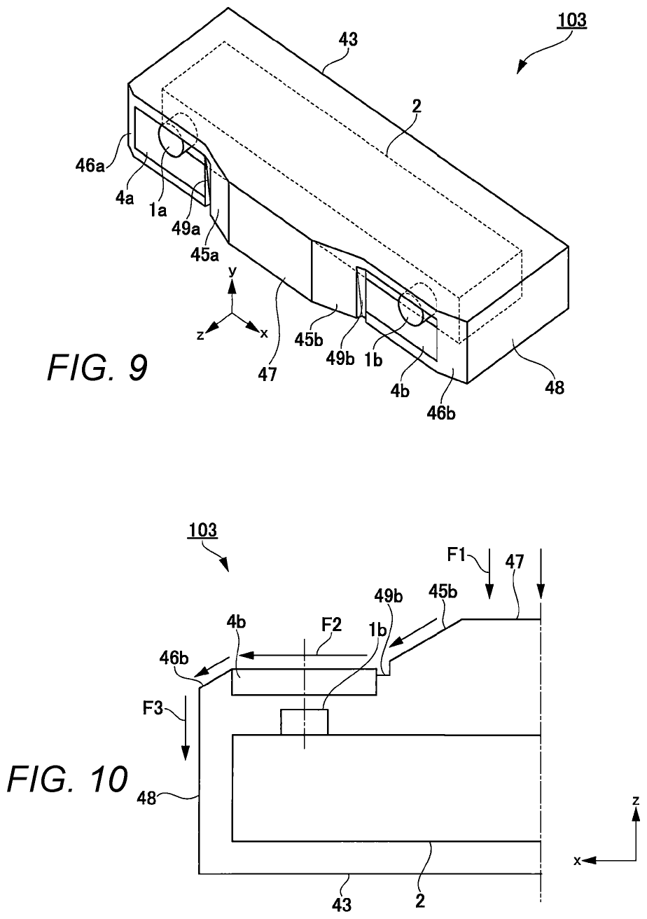

Next, a camera device according to a third embodiment will be described with reference to FIGS. 9 and 10.

FIG. 9 is a perspective view illustrating a camera device according to the third embodiment, and FIG. 10 is a plan view of the periphery of a transparent portion as viewed from above.

A camera device 103 according to the third embodiment is different from the camera device 101 according to the first embodiment in a configuration of a boundary portion between a front slope and a transparent portion. Therefore, portions common to those of the camera device 101 according to the first embodiment are denoted by one reference numeral, and redundant description will be omitted.

As illustrated in FIG. 9, the camera device 103 according to the third embodiment includes a stereo camera 2 and a waterproof case 43 illustrating an example of a housing component. The transparent portions 4a and 4b are provided at positions facing the lenses 1a and 1b in a front surface portion 47 of the waterproof case 43.

A front slope 45a is formed on the center side of the first transparent portion 4a in the first direction X, and a rear slope 46a is formed on a side surface portion 48 side of the first transparent portion 4a in the first direction X. Similarly, a front slope 45b is formed on the center side of the second transparent portion 4b in the first direction X, and a rear slope 46b is formed on the side surface portion 48 side of the second transparent portion 4b in the first direction X.

In addition, a first groove 49a is formed between the first transparent portion 4a and the front slope 45a, and similarly, a second groove 49b is formed between the second transparent portion 4b and the front slope 45b. Since the groove 49a and the groove 49b have the same configuration, the second groove 49b will be described.

As illustrated in FIGS. 9 and 10, the second groove 49b is formed along the second direction Y, which is the vertical direction, at one end portion of the second transparent portion 4b on the central side. The lower end of the second groove 49b in the vertical direction is open. As illustrated in FIG. 10, the second groove 49b is a recess recessed from the front to the rear in the third direction Z.

The water droplet M1 flowing along the front slope 45b by the first guide wind F2 enters the second groove 49b. Then, the water droplet M1 entering the second groove 49b is discharged to the outside of the waterproof case 43 from the lower side in the vertical direction along the second groove 49b. As a result, the water droplet M1 contained in the first guide wind F2 can be removed before being attached to the second transparent portion 4b, and the water droplet M1 attached to the second transparent portion 4b can be efficiently removed by the first guide wind F2.

The depth of the lower end portion in the vertical direction of the second groove 49b is formed deeper than the depth of the upper end portion in the vertical direction. That is, the second groove 49b is inclined such that the depth continuously increases from the upper end toward the lower end along the vertical direction. As a result, the water droplet M1 entering the second groove 49b is easily discharged from the lower end portion of the second groove 49b.

Other configurations are similar to those of the camera device 101 according to the first embodiment, and thus, description thereof will be omitted. The camera device 103 having such a configuration can also obtain the same operational effects as those of the camera device 101 according to the first embodiment described above.

### 4. Fourth Embodiment

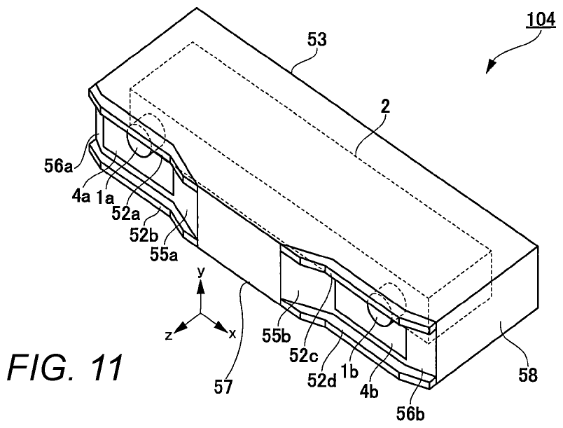

Next, a camera device according to a fourth embodiment will be described with reference to FIG. 11.

FIG. 11 is a perspective view illustrating the camera device according to the fourth embodiment.

A camera device 104 according to the fourth embodiment is different from the camera device 101 according to the first embodiment in that an eave is provided. Therefore, portions common to those of the camera device 101 according to the first embodiment are denoted by one reference numeral, and redundant description will be omitted.

FIG. 11, the camera device 104 according to the fourth embodiment includes a stereo camera 2 and a waterproof case 53 illustrating an example of a housing component. The transparent portions 4a and 4b are provided at positions facing the lenses 1a and 1b in a front surface portion 57 of the waterproof case 53.

A front slope 55a is formed on the center side of the first transparent portion 4a in the first direction X, and a rear slope 56a is formed on a side surface portion 58 side of the first transparent portion 4a in the first direction X. Similarly, a front slope 55b is formed on the center side of the second transparent portion 4b in the first direction X, and a rear slope 56b is formed on the side surface portion 58 side of the second transparent portion 4b in the first direction X.

A first upper eave 52a is provided at an upper end of the first transparent portion 4a in the vertical direction (second direction Y), and a first lower eave 52b is provided at a lower end of the first transparent portion 4a in the vertical direction. The first upper eave 52a and the first lower eave 52b are disposed so as to sandwich the first transparent portion 4a. Similarly, a second upper eave 52c is provided at an upper end of the second transparent portion 4b in the vertical direction, and a second lower eave 52d is provided at a lower end of the second transparent portion 4b in the vertical direction. The second upper eave 52c and the second lower eave 52d are disposed so as to sandwich the second transparent portion 4b. That is, the eaves 52a, 52b, 52c, and 52d are provided at ends in a direction (second direction Y) orthogonal to the direction (first direction X) in which the slopes 55a, 55b, 56a, and 56b are provided with respect to the transparent portions 4a and 4b.

Each of the first upper eave 52a, the first lower eave 52b, the second upper eave 52c, and the second lower eave 52d protrudes forward in the third direction Z. In addition, the first upper eave 52a and the first lower eave 52b are continuously formed over the front slope 55a, the first transparent portion 4a, and the rear slope 56a along the first direction X. The second upper eave 52c and the second lower eave 52d are continuously formed over the front slope 55b, the second transparent portion 4b, and the rear slope 56b along the first direction X.

The first guide wind F2 and the second guide wind F3 flow between the first upper eave 52a and the first lower eave 52b.

In addition, the first guide wind F2 and the second guide wind F3 flow between the second upper eave 52c and the second lower eave 52d. The eaves 52a, 52b, 52c, and 52d serve as a wind path for guide air.

By providing the eaves 52a, 52b, 52c, and 52d in this manner, it is possible to suppress the first guide wind F2 passing over one surface of the first transparent portion 4a and the second transparent portion 4b from escaping in the vertical direction.

As a result, the air volume of the first guide wind F2 flowing along the first direction X can be increased, and the ability to remove the water droplet M1 by the first guide wind F2 can be improved.

Other configurations are similar to those of the camera device 101 according to the first embodiment, and thus, description thereof will be omitted. The camera device 104 having such a configuration can also obtain the same operational effects as those of the camera device 101 according to the first embodiment described above.

### 5. Fifth Embodiment

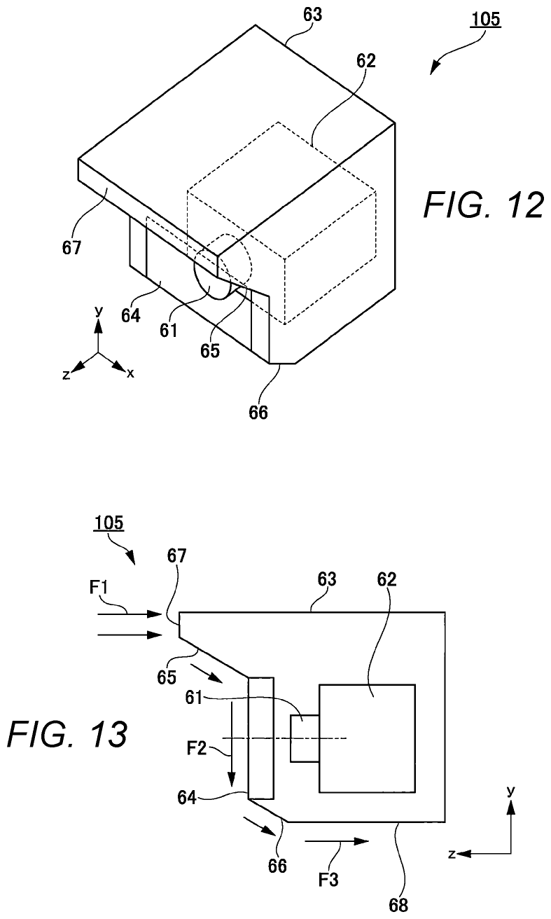

Next, a camera device according to a fifth embodiment will be described with reference to FIGS. 12 and 13.

FIG. 12 is a perspective view illustrating the camera device according to the fifth embodiment, and FIG. 13 is a side view.

A camera device 105 according to the fifth embodiment is different from the camera device 101 according to the first embodiment in that a front slope and a rear slope are provided. Therefore, portions common to those of the camera device 101 according to the first embodiment are denoted by one reference numeral, and redundant description will be omitted.

As illustrated in FIGS. 12 and 13, the camera device 105 includes a monocular camera 62 and a waterproof case 63 illustrating an example of a housing component. The monocular camera 62 includes one lens 61 and an imaging element (not illustrated). The monocular camera 62 is accommodated in the waterproof case 63.

The waterproof case 63 is formed in a hollow container shape. A transparent portion 64 is provided at a position facing the lens 61 in a front surface portion 67 of the waterproof case 63. A front slope 65 is provided above the transparent portion 64 in the vertical direction (second direction Y), and a rear slope 66 is provided below the transparent portion 64 in the vertical direction.

The front slope 65 is inclined toward the front in the third direction Z as the front slope 65 goes upward in the vertical direction from one end portion that is an upper end of the transparent portion 64 in the vertical direction. The rear slope 66 is inclined toward the rear side in the third direction Z as the rear slope 66 goes downward in the vertical direction from the other end portion which is the lower end portion of the transparent portion 64 in the vertical direction.

As illustrated in FIG. 13, when the traveling wind F1 is applied to the waterproof case 63 from the front of the camera device 105, the direction of the traveling wind F1 is first changed along the second direction X by the front slope 65 and is changed to the first guide wind F2. The first guide wind F2 flows downward in the vertical direction along the front slope 65 and passes on one surface of the transparent portion 64 from the upper portion to the lower portion in the vertical direction.

The first guide wind F2 that has passed through the transparent portion 64 changes its direction toward the rear side in the third direction Z by the rear slope 66, and becomes the second guide wind F3. Then, the second guide wind F3 flows to the rear side of the waterproof case 63 along a bottom surface portion 68 of the waterproof case 63.

In addition, by disposing the front slope 65 in the upper portion and disposing the rear slope 66 in the lower portion, not only the first guide wind F2 but also gravity acts on the water droplet M1. As a result, the removal of the water droplet M1 from the transparent portion 64 can be promoted.

Other configurations are similar to those of the camera device 101 according to the first embodiment, and thus, description thereof will be omitted. The camera device 105 having such a configuration can also obtain the same operational effects as those of the camera device 101 according to the first embodiment described above.

Note that, although the example of using the monocular camera 62 has been described in the camera device 105 according to the fifth embodiment, the type of camera is not limited thereto, and various other cameras such as a stereo camera and a triplet-lens camera can be applied.

### 6. Sixth Embodiment

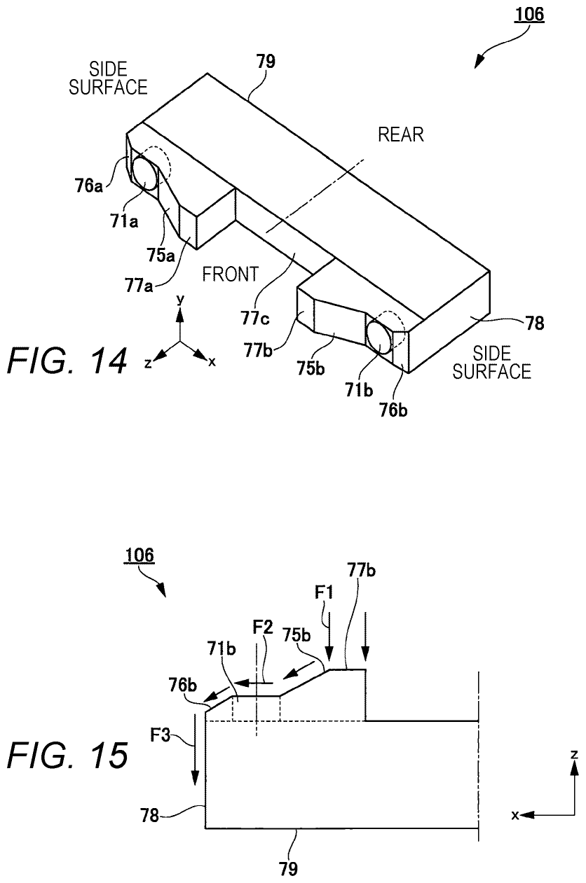

Next, a camera device according to a sixth embodiment will be described with reference to FIGS. 14 and 15.

FIG. 14 is a perspective view illustrating a camera device according to the sixth embodiment, and FIG. 15 is a plan view of the periphery of a lens as viewed from above.

A camera device 106 according to the sixth embodiment is different from the camera device 101 according to the first embodiment in that a waterproof case is not provided. Therefore, portions common to those of the camera device 101 according to the first embodiment are denoted by one reference numeral, and redundant description will be omitted.

As illustrated in FIGS. 14 and 15, the camera device 106 includes two lenses 71a and 71b and a housing 79 illustrating an example of a housing component. The housing 79 is a housing having a waterproof function. In the housing 79, the two lenses 71a and 71b indicating transparent portions are provided at intervals in the first direction X. The front of the lenses 71a and 71b in the third direction Z is formed in a planar shape. Alternatively, a planar transparent portion may be provided in front of the lenses 71a and 71b. In a front surface portion of the housing 79 where the two lenses 71a and 71b are provided, a first front surface portion 77a, a second front surface portion 77b, front slopes 75a and 75b, rear slopes 76a and 76b, and a recess 77c are formed.

The recess 77c is formed at an intermediate portion in the first direction X. The first front surface portion 77a is formed at one end portion of the recess 77c in the first direction X, and the second front surface portion 77b is formed at the other end portion of the recess 77c in the first direction X. The recess 77c is recessed rearward in the third direction Z with respect to the first front surface portion 77a and the second front surface portion 77b.

The front slope 75a, the lens 71a, and the rear slope 76a are arranged between the first front surface portion 77a and a side surface portion 78 of the housing 79, and the front slope 75b, the lens 71b, and the rear slope 76b are arranged between the second front surface portion 77b and the side surface portion 78 of the housing 79. Since the configuration around the first lens 71a and the configuration around the second lens 71b have the same configuration, the configuration around the second lens 71b will be described here.

As illustrated in FIG. 15, the front slope 75b is formed at one end portion of the second lens 71b on the central side in the first direction X. The front slope 75b is inclined forward in the third direction Z as the front slope 75b goes from one end portion of the second lens 71b toward the second front surface portion 77b. The rear slope 76b is formed at the other end portion of the second lens 71b on the outer side in the first direction X. The rear slope 76b is inclined rearward in the third direction Z as the rear slope 76b goes from the other end portion of the second lens 71b toward the side surface portion 78. Therefore, the front slope 75b is disposed in front of the second lens 71b in the third direction Z, and the rear slope 76b is disposed behind the second lens 71b in the third direction Z.

When the traveling wind F1 is applied to the housing 79 from the front of the camera device 106, the direction of the traveling wind F1 changes in a direction parallel to the first direction X by the front slopes 75a and 75b, and the traveling wind F1 changes to the first guide wind F2. Then, the first guide wind F2 passes on one surface of the lenses 71a and 71b as the transparent portions from the center side toward the outside in the first direction X. Therefore, the water droplets M1 attached to the transparent portions 71a and 71b are removed by the first guide wind F2.

In addition, the direction of the first guide wind F2 that has passed through the lenses 71a and 71b is changed to the second guide wind F3 that is directed rearward in the third direction Z by the rear slopes 6a and 6b. Then, the second guide wind F3 flows to the rear side of the housing 79 along the side surface portion 78 of the waterproof case 3.

Other configurations are similar to those of the camera device 101 according to the first embodiment, and thus, description thereof will be omitted. The camera device 106 having such a configuration can also obtain the same operational effects as those of the camera device 101 according to the first embodiment described above.

Note that, according to the camera device 106 according to the sixth embodiment, the front slopes 75a and 75b and the rear slopes 76a and 76b are formed in the housing 79 itself. As a result, the waterproof case can be reduced, the number of components can be reduced, and the cost can be reduced.

The recess 77c provided in the housing 79 is provided for weight reduction, and the recess 77c may not be provided. Note that, in order to prioritize the flow of air, it is preferable not to provide the recess 77c in the housing 79.

The invention is not limited to the embodiments described above and illustrated in the drawings, and various modifications can be made without departing from the gist of the invention described in the claims. Further, the invention is not limited to the one having all the configurations described in the above-described embodiments, and includes ones in which a part of the configuration is deleted.

Although words such as “parallel” and “orthogonal” have been used in the present specification, these do not mean only strict “parallel” and “orthogonal”, but include “parallel” and “orthogonal”. Further, it may be in a “substantially parallel” or “substantially orthogonal” state within a range in which the function can be exhibited.

### REFERENCE SIGNS LIST

1a, 1b, 61, 71a, 71b lens (transparent portion)
2 stereo camera (camera)
3, 33, 43, 53, 63 waterproof case (housing component)
4a, 4b, 64 transparent portion
5a, 5b, 45a, 45b, 55a, 55b, 65, 75a, 75b front slope
6a, 6b, 46a, 46b, 56a, 56d, 66, 76a, 76b rear slope
9a, 9b opening
35a, 35c first front slope
35b, 35d second front slope
36a, 36c first rear slope
36b, 36d second rear slope
49a, 49b groove
52a, 52, 52c, 52d eave
62 monocular camera (camera)
79 housing (housing component)
101, 102, 103, 104, 105, 106 camera device
F1 traveling wind
F2 first guide wind
F3 second guide wind
M1 water droplet

1. A camera device comprising:
a housing component that houses an imaging unit;
a transparent portion provided in the housing component and positioned in an imaging range of the imaging unit; and
a front slope formed from one end portion of the transparent portion in the housing component and provided in front of the transparent portion in an optical axis direction of the imaging unit,
wherein the front slope is inclined with respect to the optical axis direction.

2. The camera device according to claim 1, wherein
the housing component is provided with a rear slope formed at another end portion of the transparent portion opposite to one end portion where the front slope is formed, the rear slope being provided behind the transparent portion in the optical axis direction, and
the rear slope is inclined with respect to the optical axis direction.

3. The camera device according to claim 1, wherein an inclination angle of the front slope changes in a plurality of stages.

4. The camera device according to claim 3, wherein
the front slope includes a first front slope and a second front slope disposed closer to the transparent portion than the first front slope, and
an inclination angle of the second front slope with respect to a plane as a normal line in the optical axis direction is set to be smaller than an inclination angle of the first front slope.

5. The camera device according to claim 1, wherein a groove is formed between the front slope and the transparent portion in the housing component.

6. The camera device according to claim 1, wherein
the housing component is provided with an eave protruding forward in the optical axis direction, and
the eave is provided at an end portion of the transparent portion in a direction orthogonal to an end portion at which the front slope is provided.

7. The camera device according to claim 1, comprising:
a camera including the imaging unit; and
a waterproof case capable of housing the camera,
wherein the housing component is the waterproof case.

8. The camera device according to claim 1, comprising a camera including the imaging unit, wherein the housing component is a housing of the camera.

9. The camera device according to claim 1, wherein the transparent portion has one surface parallel to a plane orthogonal to the optical axis direction.
